(19) United States
(12) Patent Application Publication
(10) Pub. No.: US 2014/0348995 A1
(43) Pub. Date: Nov. 27, 2014

(54) SOYBEAN MILK PREPARATION METHOD OF SOYBEAN MILK PREPARATION EQUIPMENT

(71) Applicant: JOYOUNG COMPANY LIMITED, Jinan (CN)

(72) Inventors: Xuning Wang, Jinan (CN); Changluo Ji, Jinan (CN); Yongquan Zhan, Jinan (CN)

(21) Appl. No.: 14/359,912

(22) PCT Filed: Nov. 23, 2012
(86) PCT No.: PCT/CN2012/085138

§ 371 Date: May 21, 2014

(30) Foreign Application Priority Data
Nov. 25, 2011 (CN) 201110380546.0
May 25, 2012 (CN) 201210164680.1

(51) Int. Cl. A23C 11/10

(52) U.S. Cl. CPC A23C 11/103
USPC 426/431

(57) ABSTRACT

A method of making soybean milk applicable to a device of making soybean milk is provided, wherein the device includes a base, a holder for carrying a capsule, a liquid supply mechanism and an injection head; the capsule includes a container and a diaphragm for closing the container, and the method of making soybean milk includes: (a) making the injection head pass through the diaphragm to inject liquid into the capsule, wherein the liquid permeates a soybean powder layer to reach a planar, concave or convex splashing portion at a bottom of the capsule to form a liquid flow passage; and (b) continuing injecting liquid, by the injection head, into the capsule, wherein the liquid is splashed by the splashing portion to gradually dissolve the soybean powder upwards from the bottom of the capsule until the soybean powder is completely dissolved.

The present application claims the benefits of priorities to Chinese Patent Application No. 201110380546.0, titled “SOYBEAN POWDER CAPSULE, METHOD FOR MAKING SOYBEAN MILK AND DEVICE THEREOF”, filed with the Chinese State Intellectual Property Office on Nov. 25, 2011, and Chinese Patent Application No. 201210164680.1, titled “SOYBEAN POWDER CAPSULE, METHOD FOR MAKING SOYBEAN MILK AND DEVICE THEREOF”, filed with the Chinese State Intellectual Property Office on May 25, 2012, the entire disclosures of which are incorporated herein by reference.

### TECHNICAL FIELD

The present application relates to a method for making beverages, and particularly to a method for making soybean milk applicable to a device for making soybean milk

### BACKGROUND

Currently, there are two manners to make soybean milk, one manner is to crush soybeans via a conventional soybean milk maker, and then boil the crushed soybeans after being mixed with water, and another manner is to directly brew soybean powder.

The manner of making soybean milk via the soybean milk maker is time consuming, noisy, and also requires cleaning the soybean milk maker after the soybean milk making process is finished. In the manner of making soybean milk by brewing the soybean powder, a phenomenon of non-uniform brewing or caking of the soybean powder is prone to occur, which causes that the brewed soybean milk has a non-uniform concentration, thereby adversely affecting the mouthfeel of the soybean milk.

### SUMMARY

The technical problem to be solved by the present application is to provide a method for making soybean milk, which has a great soybean milk making effect.

To solve the above technical problem, a method for making soybean milk applicable to a device for making soybean milk is provided according to the present application, wherein the device of making soybean milk includes a base, a holder for carrying a capsule, a liquid supply mechanism and an injection head, and the holder, the liquid supply mechanism and the injection head are arranged on the base, and the injection head has one end in communication with the liquid supply mechanism, and the other end aiming at the capsule; the device of making soybean milk further includes a control device having a soybean milk making program;

the capsule includes a container and a diaphragm for closing the container, the container includes a bottom wall and a side wall extending upwards from the bottom wall, and the diaphragm covers an opening of the container, and

the method of making soybean milk includes:
(a) making the injection head pass through the diaphragm to inject liquid into the capsule, wherein the liquid permeates a soybean powder layer to reach a planar, concave or convex splashing portion at a bottom of the capsule to form a liquid flow passage; and
(b) continuing injecting liquid, by the injection head, into the capsule, wherein the liquid is splashed by the splashing portion to gradually dissolve the soybean powder upwards from the bottom of the capsule until the soybean powder is completely dissolved; and providing a lead-out hole, and extruding out soybean milk in the capsule via the lead-out hole.

Wherein, the lead-out hole is deviated from an extension line of the injection head,

Preferably, the method of making soybean milk further includes a stage for discharging soybean milk by inflation: inflating the capsule, and extruding out the soybean milk in the capsule via the lead-out hole by utilizing air pressure.

Preferably, the liquid flow passage coincides with a central axis of the capsule, and the lead-out hole is deviated from the central axis of the capsule.

Preferably, an injection hole of the injection head has a diameter ranging from 0.5 mm to 2 mm, and the lead-out hole has a diameter ranging from 2 mm to 6 mm.

Preferably, in the step (a), a flow rate of the liquid when flowing out of the injection hole ranges from 8 ml/s to 16 ml/s; and in the step (b), the flow rate of the liquid when flowing out of the injection hole ranges from 6 ml/s to 15 ml/s.

Preferably, in both the step (a) and the step (b), the flow rate of the liquid when flowing out of the injection hole ranges from 12 ml/s to 15 ml/s.

Preferably, in the step (a), a pressure of the liquid when flowing out of the injection hole is ranges from 0.1 MPa to 0.3 MPa, and a flow rate of the liquid when flowing out of the injection hole ranges from 12 ml/s to 16 ml/s; and in the step (b), the pressure of the liquid when flowing out of the injection hole ranges from 0.06 MPa to 0.09 MPa and the flow rate of the liquid when flowing out of the injection hole ranges from 6 ml/s to 10 ml/s.

Further, the capsule is cylindrical, and the splashing portion is circular, and a ratio of a diameter of the splashing portion to a diameter of the bottom wall of the capsule ranges from 1:3 to 1:10.

Wherein, the capsule has a volume ranging from 60 ml to 80 ml.

The present application has the following beneficial effects.

In the present application, liquid injected from the injection head permeates the soybean powder layer to reach the bottom wall of the capsule to form the liquid flow passage, thus the liquid may always flow through the liquid flow passage. When flowing by the bottom wall of the capsule, the liquid is effectively baffled and splashes to form a “fountain” effect, thus the liquid may diffuse sufficiently to increase the dissolving area, and then the liquid gradually dissolves the soybean powder upwards from the bottom of the capsule, thus the soybean powder may be dissolved more uniformly, and is not prone to cake during the dissolving process. Further, the lead-out hole is arranged, and the soybean milk in the capsule is extruded out via the lead-out hole, thus the soybean milk made in this way has a uniform concentration and a great mouthfeel.

The method for making soybean milk further includes a stage for discharging soybean milk by inflation, in this stage, the capsule is inflated, and the soybean milk in the capsule is extruded out via the lead-out hole under the air pressure. In this way, the soybean milk in the capsule may be discharged rapidly, thereby reducing the soybean milk discharge time, and improving the overall efficiency of making soybean milk. Furthermore, by utilizing the air pressure, the soybean milk in the capsule may be discharged more thoroughly, which avoids waste caused by a large amount of soybean milk remained in the capsule.

The liquid flow passage coincides with the central axis of the capsule, in this way, the liquid may be distributed more uniformly, and form a better “fountain” effect, thus the soybean powder may be dissolved more uniformly. The lead-out hole is deviated from the central axis of the capsule, which may prevent the liquid from being discharged via the lead-out hole without completely dissolving the soybean powder.

The bottom wall of the capsule is provided with a splashing portion at a position corresponding to the liquid flow passage, and the liquid is splashed by the splashing portion to gradually dissolve the soybean powder from the bottom of the capsule. When flowing by the splashing portion on the bottom wall of the capsule, the liquid forms the “fountain” effect, which may realize a better dissolving effect of the soybean powder.

The liquid flow passage has a longitudinal cross section in a tapered shape, and has a taper ranging from 0 degree to 15 degree. When the taper is larger than 15 degree, the flow rate and pressure of the liquid are greatly reduced due to the resistance three of the soybean powder layer, thus the liquid cannot form a great “fountain” effect.

In the pre-dissolving stage, the flow rate of the liquid when flowing out of the injection hole ranges from 8 ml/s to 16 ml/s. Further, in the pre-dissolving stage, the pressure of the liquid ranges from 0.1 MPa to 0.3 MPa, and the flow rate thereof ranges from 12 ml/s to 16 ml/s. When the pressure of the liquid is less than 0.1 MPa and the flow rate thereof is less than 12 ml/s, the liquid has a small permeating force, thus the liquid cannot rapidly permeate the soybean powder layer, and the soybean powder is prone to cake at the bottom portion, which may cause a poor brewing effect, or even failure to brew the soybean powder. When the pressure of the liquid is greater than 0.3 MPa and the flow rate thereof is greater than 16 ml/s, it may lead to a too strict requirement on the pressure of the whole water supply system, especially for the water pump, and a water pump having a large power and large volume is required, therefore, the pressure and the flow rate of the liquid cannot be too great. Based on the above reasons, in the pre-dissolving stage, the flow rate of the liquid when flowing out of the injection hole preferably ranges from 12 ml/s to 15 ml/s.

In the dissolving stage, the flow rate of the liquid when flowing out of the injection hole ranges from 6 ml/s to 15 ml/s. Further, in the dissolving stage, the pressure of the liquid ranges from 0.06 MPa to 0.09 MPa and the flow rate thereof ranges from 6 ml/s to 10 ml/s. When the pressure of the liquid is less than 0.06 MPa and the flow rate thereof is less than 6 ml/s, the flow of the liquid in the cavity is too slow, which is disadvantageous for the dissolving of the soybean powder, and the soybean powder is brewed slowly, which may cause a long making time. When the pressure of the liquid is greater than 0.09 MPa and the flow rate thereof is greater than 10 ml/s, the flow of the liquid is too fast, and the soybean powder may be discharged out of the cavity without being dissolved, thus the soybean powder is not sufficiently dissolved, and the soybean milk has a non-uniform concentration. Based on the above reasons, in the dissolving stage, the flow rate of the liquid when flowing out of the injection hole preferably ranges from 12 ml/s to 15 ml/s.

The injection hole of the injection head has a diameter ranging from 0.5 mm to 2 mm, and the lead-out hole of the lead-out needle has a diameter ranging from 2 mm to 6 mm. When the diameter of the injection hole is smaller than 0.5 mm, the injection flow of the liquid flow in the pre-dissolving stage has a too small taper, and is thready, which causes that the splashing occurs in a small scope and is disadvantageous for the dissolving at the bottom portion, and furthermore, the manufacturing difficulty of the hole with a diameter smaller than 0.5 mm is greatly increased. When the diameter of the injection hole is larger than 2 mm, the blocking area for the liquid flow is increased, which weakens the penetrating capacity of the liquid flow, thus the liquid flow cannot permeate the soybean powder layer rapidly. An optimum diameter of the injection hole is 1 mm. When the diameter of the lead-out hole of the lead-out needle is smaller than 2 mm, the lead-out hole of the lead-out needle is prone to be blocked by the soybean powder, which may cause failure to brew the soybean powder. When the diameter of the lead-out hole of the lead-out needle is larger than 6 mm, the soybean powder is prone to leak from the lead-out hole of the lead-out needle. An optimum diameter of the lead-out hole is 3 mm.

The capsule has a diameter ranging from 50 mm to 60 mm and a height ranging from 30 mm to 40 mm. The longitudinal cross section of the capsule is in an isosceles trapezoid shape, and an obliqueness of a non-parallel line ranges from 0 degree to 10 degree. When the capsule has a diameter smaller than 50 mm and a height less than 30 mm, the capsule can only contain a small amount of soybean powder, which may cause that the soybean milk made from the soybean powder has a low quantity or a low concentration. When the capsule has a diameter smaller than 50 mm and a height greater than 40 mm, the capsule is in a tall and thin shape, which imposes a high requirement on the permeating ability of the liquid for permeating the soybean powder layer in brewing, which is disadvantageous for the brewing. When the capsule has a diameter larger than 50 mm and a height greater than 40 mm, it may lead to a higher requirement on the brewing, and requires a higher permeating ability, and meanwhile requires the liquid being splashed at the bottom portion to reach a higher height, which is disadvantageous for the brewing. Therefore, the diameter and the height of the capsule are required to be set appropriately, so as to achieve an optimum effect.

### BRIEF DESCRIPTION OF THE DRAWINGS

FIG. 1 is a schematic view showing a first embodiment of a device for ma soybean milk according to the present application;

FIG. 2 is a schematic view showing a first embodiment of a soybean powder capsule according to the present application;

FIG. 3 is a schematic view showing the capsule of FIG. 2 in a pre-dissolving stage of a method for making soybean milk according to the present application;

FIG. 4 is a schematic view showing the capsule of FIG. 2 in a dissolving stage of the method for making soybean milk according to the present application;

FIG. 5 is a schematic view showing a second embodiment of the soybean powder capsule according to the present application;

FIG. 6 is a schematic view showing a second embodiment of the device for making soybean milk according to the present application;

FIG. 7 is a schematic view showing a third embodiment of the soybean powder capsule according to the present application;

FIG. 8 is a schematic view showing the capsule of FIG. 7 in a pre-dissolving stage of a method for making soybean milk according to the present application; and

FIG. 9 is a schematic view showing the capsule of FIG. 7 in a dissolving stage of the method for making soybean milk according to the present application.

### REFERENCE NUMERALS

| | |
|---|---|
| 10 device for making soybean milk, | 11 base, |
| 12 capsule, | 121 diaphragm, |
| 122 container, | 1221 bottom wall, |
| 1222 side wall, | 123 splashing portion, |
| 13 holder, | 131 holder body, |
| 132 holder cover, | 133 lead-out needle, |
| 1331 lead-out hole, | 14 liquid supply mechanism, |
| 141 water pump, | 142 water tank, |
| 15 injection head, | 151 injection hole, |
| 16 soybean milk containing cup, | 17 control device, |
| 18 liquid flow passage, | 20 device for making soybean |
| | milk, |
| 21 air pump, | 71 protruding portion, and |
| 31 concave surface. | |

### DETAILED DESCRIPTION

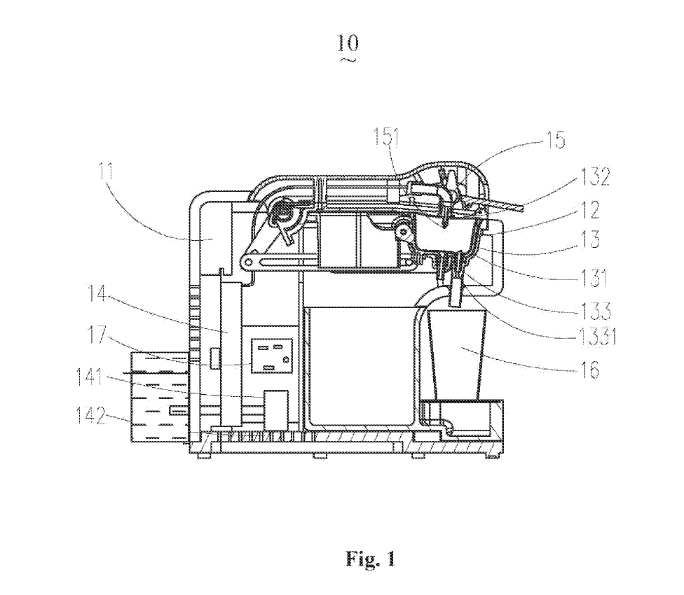

Reference is made to FIG. 1, which is a schematic view showing a first embodiment of a device for making soybean milk according to the present application. The device 10 for making soybean milk includes a base 11, a holder 13 for carrying a capsule 12, a liquid supply mechanism 14, an injection head 15, a soybean milk containing cup 16, and a control device 17 having a soybean milk making program. The holder 13, the liquid supply mechanism 14 and the injection head 15 are arranged on the base 11. The injection head 15 has one end in communication with the liquid supply mechanism 14, and the other end aiming at the capsule 12. The soybean milk making program includes a method for making soybean milk.

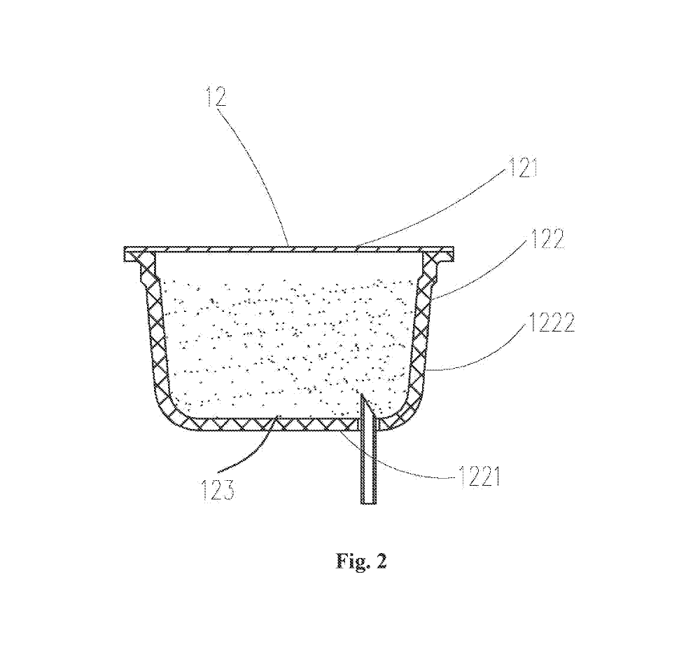

Reference is made to FIG. 2, which is a schematic view showing a first embodiment of a soybean powder capsule according to the present application. The capsule 12 includes a diaphragm 121 and a container 122. The container 122 includes a bottom wall 1221, and a side wall 1222 extending upwards from the bottom wall 1221, and the diaphragm 121 covers an opening of the container 122. In this embodiment, an open end of the capsule has a diameter larger than or equal to a diameter of the bottom wail of the capsule, and the diameter of each of the open end and the bottom wall of the capsule 12 ranges from 50 mm to 60 mm, and the capsule 12 has a height ranging from 30 mm to 40 mm. The capsule 12 has a longitudinal cross section of an isosceles trapezoid shape, and an obliqueness of a non-parallel side of the isosceles trapezoid ranges from 0 degree to 10 degree. The bottom wall 1221 of the capsule 12 forms a splashing portion 123. In this embodiment, the splashing portion 123 is a planar surface.

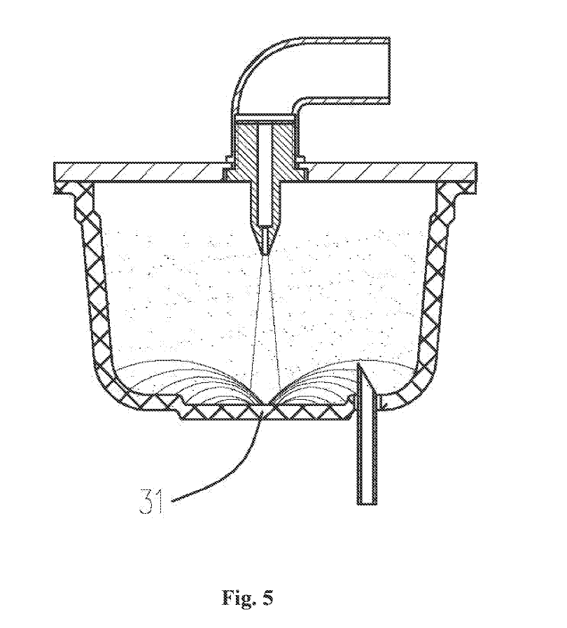

Reference is made to FIG. 5, which is a schematic view showing a second embodiment of the soybean powder capsule according to the present application. The splashing portion 123 may also be a concave surface, for example, a concave surface 31 formed by the bottom wall, which is concave downwards, of the capsule.

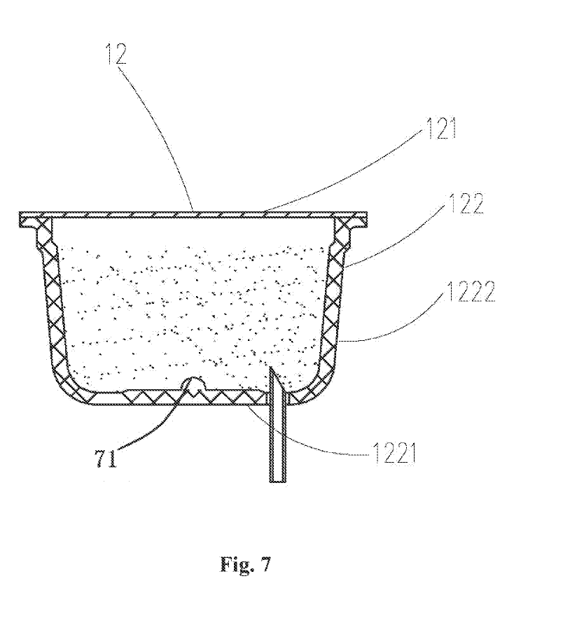

Reference is made to FIG. 7, which is a schematic view showing a third embodiment of the soybean powder capsule according to the present application. Unlike the embodiment shown in FIG. 2, in the third embodiment, the bottom wall 1221 of the capsule 12 is further provided with a protruding portion. 71 forming a splashing portion. The protruding portion 71 may be a circular arc-shaped curved surface formed by an arched portion of the bottom wall 1221 of the capsule, or a protrusion arranged separately.

In a case that the splashing portion 123 is in a circular shape, a ratio of a diameter of the splashing portion 123 to a diameter of the circular bottom wall of the capsule ranges from 1:3 to 1:10, and the ratio may be 1:3, 1:4, 1:5, 1:6, 1:7, 1:8, 1:9, or 1:10, and preferably is 1:4.

The holder 13 includes a holder body 131 and a holder cover 132. The holder body 131 has a cavity for accommodating the capsule 12. The holder body 131 is arranged with a lead-out needle 133, and the lead-out needle 133 is of a hollow structure forming a lead-out hole 1331. The lead-out hole 1331 is deviated from an extension line of the injection head 15, and has a diameter ranging from 2 mm to 6 mm. When the holder cover 132 is closed, the lead-out needle 133 pricks into the capsule, and in brewing the capsule, the lead-out hole 1331 is in communication with the cavity of the holder 131. For ensuring the soybean powder to be sufficiently dissolved in the cavity, theoretically, the smaller the diameter of the lead-out hole 1331, the better the dissolving effect. However, considering that the lead-out hole is prone to be blocked by the soybean powder, the diameter of the lead-out hole cannot be too small and should in an appropriate range, and through experiment, the diameter of the lead-out hole 1331 is preferably 3 mm. The holder cover 132 is configured to open and close the opening of the cavity, and to seal the cavity.

The liquid supply mechanism 14 includes a water pump 141 and a water tank 142. The water pump 141 has one end connected to the water tank 142, and the other end connected to the injection head 15.

The injection head 15 is arranged on the holder cover 132, and is of a hollow structure forming an injection hole 151. The injection hole 151 has a diameter ranging from 0.5 mm to 2 mm (for example, it may be 0.5, 0.6, 0.7, 0.8, 0.9, 1.0, 1.1, 1.2, 1.3, 1.4, 1.5, 1.6, 1.7, 1.8, 1.9 or 2.0 mm). In brewing the capsule, when the diameter of the injection hole is smaller than 0.5 mm, the injection flow of the liquid flow in a pre-dissolving stage has a too small taper, and is thready, thus the splashing occurs in a small scope, and furthermore, the manufacturing difficulty of the hole with a diameter smaller than 0.5 mm is greatly increased, thereby increasing the manufacturing cost. When the diameter of the injection hole is larger than 2 mm, the blocking area for the liquid flow is increased, which weakens the penetrating capacity of the liquid flow, and increases the pre-dissolving time. An optimum diameter of the injection hole is 1 mm.

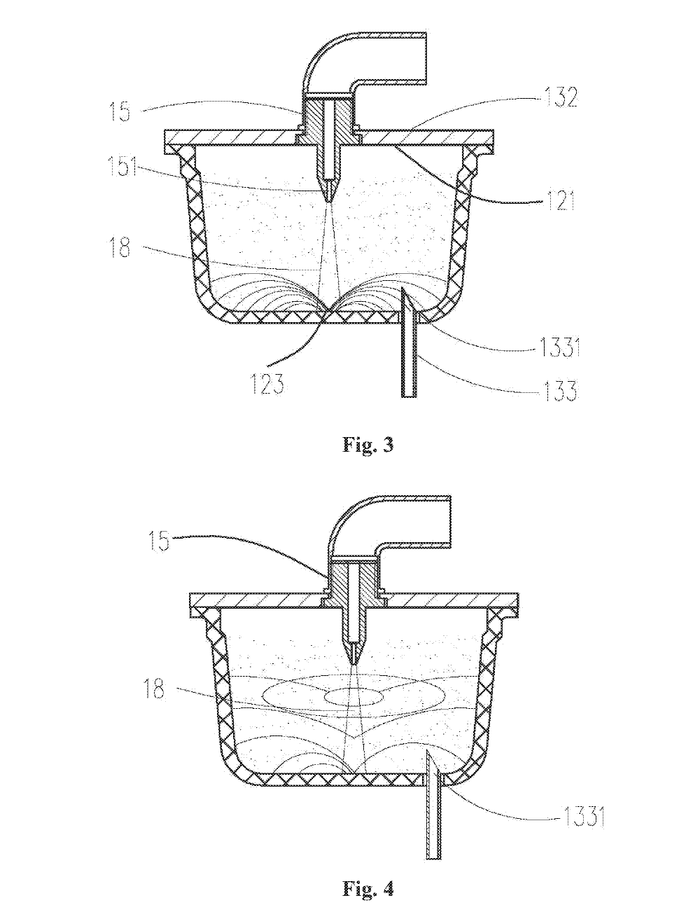

Reference is made to FIGS. 3 and 4, which show the capsule of FIG. 2 in a pre-dissolving stage and a dissolving state of a method for making soybean milk according to the present application. The method of making soybean milk by using the device 10 for making soybean milk includes the following stages.

(a) Pre-dissolving stage: the injection head 15 passes through the diaphragm 121 and injects liquid into the capsule 12, and the liquid permeates a soybean powder layer to reach a planar splashing portion 123 at the bottom wall 1221 of the capsule 12 to form a liquid flow passage 18.

(b) Dissolving stage: the injection head 15 continues injecting liquid into the capsule 12, the liquid is splashed upwards by the splashing portion 123 to gradually dissolve the soybean powder upwards from the bottom of the capsule 12 until the soy bean powder is completely dissolved, and meanwhile, soybean milk in the capsule 12 is extruded out via the lead-out hole 1331.

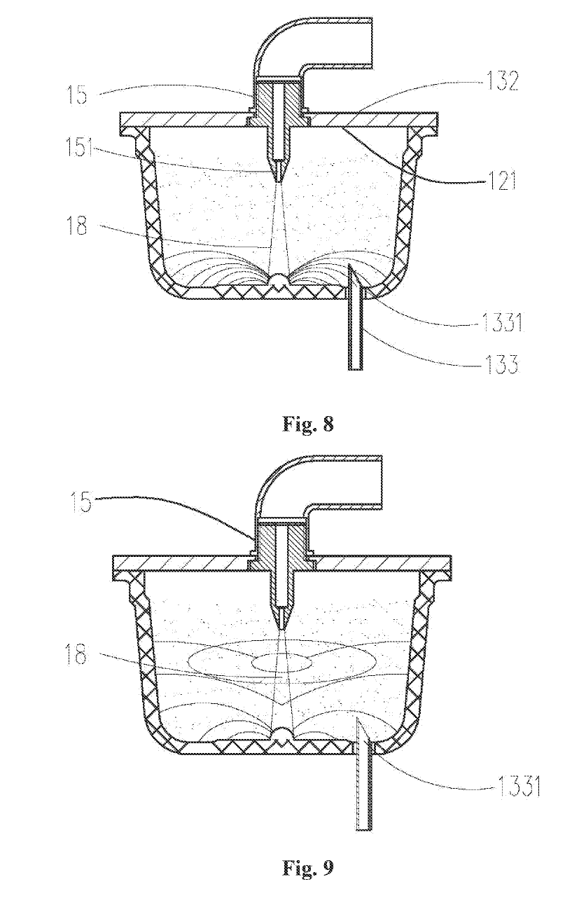

Reference is made to FIGS. 8 and 9, which show the capsule of FIG. 7 in a pre-dissolving stage and a dissolving state of a method for making soybean milk according to the present application. Another embodiment of the method of making soybean milk by using the device 10 for making soybean milk includes the following stages.

(a) Pre-dissolving stage: the injection head 15 passes through the diaphragm 121 and injects liquid into the capsule 12, and the liquid permeates a soybean powder layer to reach a convex splashing portion 123 at the bottom wall 1221 of the capsule 12 to form a liquid flow passage 18.

(b) Dissolving stage: the injection head 15 continues injecting liquid into the capsule 12, the liquid is splashed by the protruding portion of the bottom wall 1221 of the capsule 12 to gradually dissolve the soybean powder upwards from the bottom of the capsule 12 until the soybean powder is completely dissolved, and meanwhile, soybean milk in the capsule 12 is extruded out via the lead-out hole 1331.

In the above two embodiments of the method for making soybean milk, a flow rate of the liquid when flowing out of the injection hole in the pre-dissolving stage ranges from 8 ml/s to 16 ml/s. Preferably, a pressure of the liquid when flowing out of the injection head 15 in the pre-dissolving stage ranges from 0.1 MPa to 0.3 MPa, and the flow rate thereof ranges from 12 ml/s to 16 ml/s. For example, the flow rate may be 8, 8.2, 8.5, 8.6, 8.9, 9.0, 9.3, 9.4, 9.6, 9.8, 9.9, 10.0, 10.1, 10.3, 10.6, 10.7, 10.9, 11.0, 11.2, 11.3, 11.4, 11.6, 11.8, 11.9, 12.0, 12.1, 12.3, 12.4, 12.6, 12.7, 12.9, 13.0, 13.1, 13.2, 13.4, 13.6, 13.7, 13.8, 13.9, 14.0, 14.1, 14.2, 14.3, 14.5, 14.6, 14.8, 14.9, 15.0, 15.1, 15.3, 15.4, 15.7, 15.9, 16.0 ml/s, and etc.; and the pressure may be 0.1, 0.12, 0.13, 0.14, 0.15, 0.17, 0.18, 0.19, 0.2, 0.21, 0.23, 0.25, 0.27, 0.28, 0.29, 0.30 MPa, and etc. More preferably, the flow rate of the liquid when flowing out of the injection hole in the pre-dissolving stage (a) ranges from 12 ml/s to 15 ml/s.

The liquid flow passage 18 coincides with a central axis of the capsule 12, and the lead-out hole 1331 is deviated from the central axis of the capsule 12. The liquid flow passage 18 has a longitudinal cross section in a tapered shape, and has a taper ranging from 0 degree to 15 degree. When the taper is larger than 15 degree, the flow rate and pressure of the liquid are greatly reduced due to the resistance force of the soybean powder layer, thus the liquid cannot form a great “fountain” effect. An optimum value of the taper is 8 degree.

In the above two embodiments of the method for making soybean milk, a flow rate of the liquid when flowing out of the injection hole in the dissolving stage ranges from 6 ml/s to 15 ml/s. Preferably, a pressure of the liquid when flowing out of the injection head in the dissolving stage ranges from 0.06 MPa to 0.09 MPa, and the flow rate thereof ranges from 6 ml/s to 10 ml/s. For example, the flow rate may be 6, 6.1, 6.2, 6.3, 6.5, 6.7, 6.9, 7.0, 7.1, 7.3, 7.4, 7.6, 7.8, 7.9, 8.0, 8.1, 8.2, 8.4, 8.5, 8.7, 8.9, 9.0, 9.1, 9.2, 9.4, 9.6, 9.7, 9.9, 10.0, 10.1, 10.2, 10.4, 10.5, 10.6, 10.8, 10.9, 11.0, 11.1, 11.3, 11.4, 11.5, 11.6, 11.8, 11.9, 12.0, 12.3, 12.4, 12.5, 12.6, 12.8, 12.9, 13.0, 13.2, 13.3, 13.5, 13.6, 13.7, 13.9, 14.0, 14.2, 14.6, 14.7, 14.9, 15 ml/s and etc.; and the pressure may be 0.06, 0.07, 0.08, 0.09 MPa, and etc. More preferably, the flow rate of the liquid when flowing out of the injection hole in the dissolving stage (b) ranges from 12 ml/s to 15 ml/s.

In the present application, liquid injected from the injection head 15 permeates the soybean powder layer to reach the splashing portion of the capsule 12 to form the liquid flow passage 18, thus the liquid may always flow through the liquid flow passage 18. When flowing by the splashing portion of the capsule 12, the liquid is effectively baffled by the splashing portion and splashes to form the “fountain” effect, thus the liquid may diffuse sufficiently to increase the dissolving area, and then the liquid gradually dissolves the soybean powder upwards from the bottom of the capsule 12, thus the soybean powder may be dissolved more uniformly, and is not prone to cake during the dissolving process. Further, the lead-out hole 1331 is arranged, and the soybean milk in the capsule 12 is extruded out via the lead-out hole 1331, thus the soybean milk made in this way has a uniform concentration and a great mouthfeel.

It should be understood that, the device for making soybean milk further includes a waste box for storing waste capsules.

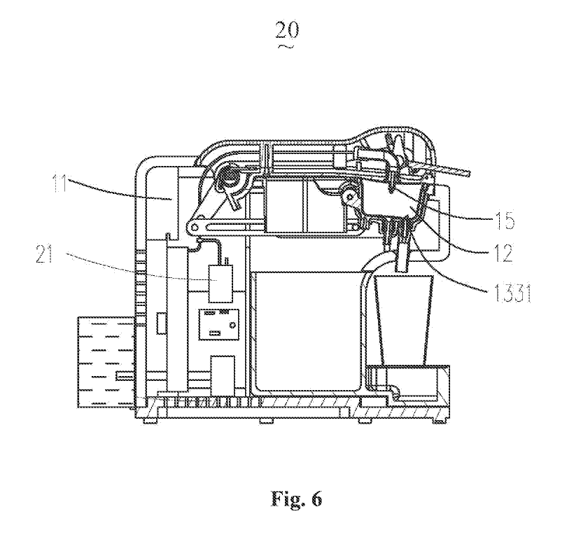

Reference is made to FIG. 6, which is a schematic view showing a second embodiment of the device for making soybean milk according to the present application. Unlike the device 10 for making soybean milk, the device 20 for making soybean milk as shown in the Figure further includes an air pump 21 mounted on the base 11. The air pump 21 has one end in communication with the outside, and the other end connected to the injection head 15.

The method for making soybean milk further includes a stage for discharging soybean milk by inflation, in this stage, the capsule 12 is inflated by the air pump 21, and the soybean milk in the capsule 12 is extruded out via the lead-out hole 1331 under the air pressure. In this way, the soybean milk in the capsule 12 may be discharged rapidly, thereby reducing the soybean milk discharge time, and improving the overall efficiency of making soybean milk. Furthermore, by utilizing the air pressure, the soybean milk in the capsule 12 may be discharged more thoroughly, which avoids waste caused by a large amount of soybean milk remained in the capsule 12.

Furthermore, a volume of the capsule ranges from 60 ml/s to 80 ml/s, for example, it may be 60, 61, 62, 63, 64, 65, 66, 67, 68, 69, 70, 71, 72, 73, 74, 75, 76, 77, 78, 79, 80 ml, and etc. Preferably, the volume may be 70 ml. The volume set within such range may realize a better cooperation between the volume of the capsule and factors such as the diameter of the lead-out hole, the diameter of the injection hole and the flow rate, thus the soybean powder in the capsule may have a better dissolving effect.

Other structures and beneficial effects of this embodiment are the same as those of the above embodiments, which will not be described in detail herein for simplicity.

The above description is only exemplary embodiments of the present application. It should be noted that, for the person skilled in the art, many modifications and improvements may be made to the present application without departing from the principle of the present application. The protection scope of the present application is defined by the claims.

1. A method of making soybean milk applicable to a device of making soybean milk, wherein the device of making soybean milk comprises a base, a holder for carrying a capsule, a liquid supply mechanism and an injection head, and the holder, the liquid supply mechanism and the injection head are arranged on the base, and the injection head has one end in communication with the liquid supply mechanism, and the other end aiming at the capsule; the device of making soybean milk further comprises a control device having a soybean milk making program;
the capsule comprises a container and a diaphragm for closing the container, the container comprises a bottom wall and a side wall extending upwards from the bottom wall, and the diaphragm covers an opening of the container, and
the method of making soybean milk comprises:
(a) making the injection head pass through the diaphragm to inject liquid into the capsule, wherein the liquid permeates a soybean powder layer to reach a planar, concave or convex splashing portion at a bottom of the capsule to form a liquid flow passage; and
(b) continuing injecting liquid, by the injection head, into the capsule, wherein the liquid is splashed by the splashing portion to gradually dissolve the soybean powder upwards from the bottom of the capsule until the soybean powder is completely dissolved; and providing a lead-out hole, and extruding out soybean milk in the capsule via the lead-out hole.

2. The method of making soybean milk applicable to a device of making soybean milk according to claim 1, wherein the lead-out hole is deviated from an extension line of the injection head.

3. The method of making soybean milk applicable to a device of making soybean milk according to claim 1, further comprising a stage for discharging soybean milk by inflation: inflating the capsule, and extruding out the soybean milk in the capsule via the lead-out hole by utilizing air pressure.

4. The method of making soybean milk applicable to a device of making soybean milk according to claim 1, wherein the liquid flow passage coincides with a central axis of the capsule, and the lead-out hole is deviated from the central axis of the capsule.

5. The method of making soybean milk applicable to a device of making soybean milk according to claim 1, wherein an injection hole of the injection head has a diameter ranged from 0.5 mm to 2 mm, and the lead-out hole has a diameter ranged from 2 mm to 6 mm.

6. The method of making soybean milk applicable to a device of making soybean milk according to claim 5, wherein, in the step (a), a flow rate of the liquid when flowing out of the injection hole is ranged from 8 ml/s to 16 ml/s; and in the step (b), the flow rate of the liquid when flowing out of the injection hole is ranged from 6 ml/s to 15 ml/s.

7. The method of making soybean milk applicable to a device of making soybean milk according to claim 6, wherein, in both the step (a) and the step (b), the flow rate of the liquid when flowing out of the injection hole is ranged from 12 ml/s to 15 ml/s.

8. The method of making soybean milk applicable to a device of making soybean milk according to claim 5, wherein, in the step (a), a pressure of the liquid when flowing out of the injection hole is ranged from 0.1 MPa to 0.3 MPa, and a flow rate of the liquid when flowing out of the injection hole is ranged from 12 ml/s to 16 ml/s; and in the step (b), the pressure of the liquid when flowing out of the injection hole is ranged from 0.06 MPa to 0.09 MPa, and the flow rate of the liquid when flowing out of the injection hole is ranged from 6 ml/s to 10 ml/s.

9. The method of making soybean milk applicable to a device of making soybean milk according to claim 1, wherein the capsule is cylindrical, and the splashing portion is circular, and a ratio of a diameter of the splashing portion to a diameter of the bottom wall of the capsule is ranged from 1:3 to 1:10.

10. The method of making soybean milk applicable to a device of making soybean milk according to claim 1, wherein the capsule has a volume ranged from 60 ml to 80 ml.

11. The method of making soybean milk applicable to a device of making soybean milk according to claim 2, wherein an injection hole of the injection head has a diameter ranged from 0.5 mm to 2 mm, and the lead-out hole has a diameter ranged from 2 mm to 6 mm.

12. The method of making soybean milk applicable to a device of making soybean milk according to claim 11, wherein, in the step (a), a flow rate of the liquid when flowing out of the injection hole is ranged from 8 ml/s to 16 ml/s; and in the step (b), the flow rate of the liquid when flowing out of the injection hole is ranged from 6 ml/s to 15 ml/s.

13. The method of making soybean milk applicable to a device of making soybean milk according to claim 12, wherein, in both the step (a) and the step (b), the flow rate of the liquid when flowing out of the injection hole is ranged from 12 ml/s to 15 ml/s.

14. The method of making soybean milk applicable to a device of making soybean milk according to claim 11, wherein, in the step (a), a pressure of the liquid when flowing out of the injection hole is ranged from 0.1 MPa to 0.3 MPa, and a flow rate of the liquid when flowing out of the injection hole is ranged from 12 ml/s to 16 ml/s; and in the step (b), the pressure of the liquid when flowing out of the injection hole is ranged from 0.06 MPa to 0.09 MPa, and the flow rate of the liquid when flowing out of the injection hole is ranged from 6 ml/s to 10 ml/s.

15. The method of making soybean milk applicable to a device of making soybean milk according to claim 3, wherein an injection hole of the injection head has a diameter ranged from 0.5 mm to 2 mm, and the lead-out hole has a diameter ranged from 2 mm to 6 mm.

16. The method of making soybean milk applicable to a device of making soybean milk according to claim 15, wherein, in the step (a), a flow rate of the liquid when flowing out of the injection hole is ranged from 8 ml/s to 16 ml/s; and in the step (b), the flow rate of the liquid when flowing out of the injection hole is ranged from 6 ml/s to 15 ml/s.

17. The method of making soybean milk applicable to a device of making soybean milk according to claim 16, wherein, in both the step (a) and the step (b), the flow rate of the liquid when flowing out of the injection hole is ranged from 12 ml/s to 15 ml/s.

18. The method of making soybean milk applicable to a device of making soybean milk according to claim 15, wherein, in the step (a), a pressure of the liquid when flowing out of the injection hole is ranged from 0.1 MPa to 0.3 MPa, and a flow rate of the liquid when flowing out of the injection hole is ranged from 12 ml/s to 16 ml/s; and in the step (b), the pressure of the liquid when flowing out of the injection hole is ranged from 0.06 MPa to 0.09 MPa, and the flow rate of the liquid when flowing out of the injection hole is ranged from 6 ml/s to 10 ml/s.
